(19) United States
(12) Patent Application Publication
(10) Pub. No.: US 2018/0156202 A1
(43) Pub. Date: Jun. 7, 2018

(54) SPAR CAP ASSEMBLY FOR A WIND TURBINE ROTOR BLADE

(71) Applicant: Nordex Energy GmbH, Hamburg (DE)

(72) Inventors: Thomas Lipka, Rostock (DE); Hendrik Klein, Rostock (DE); Jochen Kremer, Hamburg (DE)

(21) Appl. No.: 15/832,399

(22) Filed: Dec. 5, 2017

(30) Foreign Application Priority Data
Dec. 5, 2016 (EP) 16202276.8

(51) Int. Cl. F03D 80/30; F03D 1/06

(52) U.S. Cl. CPC F03D 80/30; F03D 1/0675; F05B 2240/21; F05B 2240/30; F05B 2280/6003

(57) ABSTRACT

A spar cap assembly for a wind turbine rotor blade with a carbon fiber-reinforced spar cap, a lightning conductor, which extends along the spar cap, and an equipotential bonding element, which connects the spar cap and the lightning conductor together electrically conductively, wherein the spar cap includes a plurality of layers of pultruded semi-finished products and the equipotential bonding element comprises a sheet of a carbon fiber material, which rests against an end face of an end on the blade root side of one of the pultruded semi-finished products and against an end face of an end on the blade tip side of one of the pultruded semi-finished products.

### CROSS REFERENCE TO RELATED APPLICATION

This application claims priority of European patent application no. 16 202 276.8, filed Dec. 5, 2016, the entire content of which is incorporated herein by reference.

### FIELD OF THE INVENTION

The invention relates to a spar cap assembly for a wind turbine rotor blade with a carbon fiber-reinforced spar cap, a lightning conductor, which extends along the spar cap, and an equipotential bonding element, which connects the spar cap and the lightning conductor together electrically conductively.

### BACKGROUND OF THE INVENTION

The use of carbon fiber-reinforced spar caps in wind turbine rotor blades makes particular demands of lightning protection due to the electrical conductivity of the carbon fibers. In particular, equipotential bonding is generally necessary between such spar caps and other electrically conductive structures extending adjacent thereto, such as for instance conventional lightning conductors. In addition, damage may be caused to the rotor blade by arcing between the different, electrically conductive structures which may arise in the event of a lightning strike in particular as a result of electromagnetic induction.

Against this background, U.S. Pat. No. 8,118,559 proposes applying a copper strip directly to a carbon fiber laminate in a wind turbine rotor blade.

U.S. Pat. No. 9,051,921 describes a wind turbine rotor blade with a metal plate, which is brought into direct contact with a carbon fiber-containing laminate and connected to a lightning conductor via electrical lines.

A spar cap for a wind turbine rotor blade is disclosed by US 2016/0138659 which includes a laminate having layers of a carbon fiber-containing material and interlayers of another, electrically conductive material, in particular of metal.

US 2015/0292479 discloses a spar cap assembly for a wind turbine rotor blade with a carbon fiber-reinforced spar cap, a lightning conductor, which extends along the spar cap, and an equipotential bonding element, which connects the spar cap and the lightning conductor together electrically conductively. The spar cap is made of a carbon fiber laminate. A woven fabric of copper wires welded to a lightning conductor of copper and which lies in places on the carbon fiber laminate is used as the equipotential bonding element.

The use of pultruded semi-finished products for producing spar caps for wind turbine rotor blades is likewise known. As a result of being produced using a pultrusion method, the pultruded semi-finished products are distinguished by reinforcing fibers, for example carbon fibers, oriented exactly in the longitudinal direction, precisely defined cross-sections and a particularly high fiber volume content. The use of pultruded semi-finished products therefore makes it possible to produce spar caps which are superior in particular in terms of strength to conventional spar caps produced using a laminating method (for example vacuum infusion).

US 2014/0003956 discloses a spar cap for a wind turbine rotor blade which is built up from a plurality of layers of pultruded semi-finished products.

US 2016/0273516 discloses providing pultruded semi-finished products with longitudinal slots, in order to limit the expansion of air pockets when joining a plurality of semi-finished products lying in layers one on top of the other in the vacuum infusion method.

US 2016/0263844 discloses pultruded semi-finished products for wind turbine rotor blades which are provided with a special surface layer to achieve uniform distribution of the introduced resin when joining a plurality of pultruded semi-finished products lying in layers one on top of the other in the vacuum infusion method.

US 2016/0263775 discloses using a specific method to subdivide pultruded semi-finished products for wind turbine rotor blades into longitudinal portions with a given chamfer.

EP 1 844 526 B1 discloses connecting an electrical heating device of carbon fibers to electrical lines for current feed by adhesively bonding beveled ends of the carbon fibers to the electrical conductors using a conductive adhesive.

### SUMMARY OF THE INVENTION

It is an object of the invention to provide a spar cap assembly for a wind turbine rotor blade which associates optimal strength properties with functioning lightning protection.

This object can, for example, be achieved by a spar cap assembly for a wind turbine rotor blade, the spar cap assembly having:

a carbon fiber-reinforced spar cap,

a lightning conductor, which extends along the spar cap, and

an equipotential bonding element, which connects the spar cap and the lightning conductor together electrically conductively, wherein

the spar cap includes a plurality of layers of pultruded semi-finished products and

the equipotential bonding element includes a sheet of a carbon fiber material, which rests against an end face of an end on the blade, root side of one of the pultruded semi-finished products and against an end face of an end on the blade tip side of one of the pultruded semi-finished products.

The spar cap forms an element of the load-bearing structure of the wind turbine rotor blade. In particular, it may be a main spar cap, which absorbs a major part of the tensile stresses arising when the wind turbine rotor blade is in operation. The spar cap includes a plurality of pultruded semi-finished products in which carbon fibers have been incorporated. They are produced using a pultrusion method, such that a plastics matrix surrounding the reinforcing fibers is cured when the pultruded semi-finished products are incorporated in the spar cap assembly. In this case, a plurality of pultruded semi-finished products may be joined together in such a way as to form the spar cap. To this end, they are preferably embedded in a common plastics matrix, for example in a vacuum infusion method. The cross-section of the spar cap may in this case vary over the length of the spar cap, wherein to this end the number of pultruded semi-finished products arranged next to and/or on top of one another may be varied.

The lightning conductor extends along the spar cap. It may for example extend substantially parallel to the spar cap, at a distance from the spar cap, directly on the spar cap or closely adjacent thereto. The lightning conductor may extend substantially over the entire length of the spar cap and optionally also therebeyond. It has a current carrying capacity which is sufficient for carrying away lightning current. To this end, it may, for example, include copper and have an effective cross-section of 25 mm² or more, in particular of around 50 mm². The lightning conductor may be a solid metallic conductor or include a plurality of individual wires, for example in the form of braided tubing, for example of copper.

The equipotential bonding element connects the spar cap and the lightning conductor together electrically conductively. The electrical conductivity of the connection does not have to be perfect, rather it is sufficient if the potential differences arising between lightning conductor and spar cap in the event of a lightning strike are reduced to such a degree as to prevent damage to the spar cap assembly or adjacent elements of the wind turbine rotor blade, in particular resulting from arcing between lightning conductor and spar cap.

The inventors have recognized that the lightning protection means of conventional rotor blades, used in conjunction with carbon fiber laminates, are suitable only to a limited degree for spar caps of pultruded semi-finished products. The reason for this is that the pultruded semi-finished products have already been cured at the time of their electrical connection with an equipotential bonding element and have a surface which is predominantly formed of a matrix material. The carbon fibers contained therein are not contactable thereby or are only contactable thereby to a very limited extent.

In the invention sufficient electrical contacting of the spar cap is achieved in that a carbon fiber material sheet is used as the equipotential bonding element which rests against an end on the blade root side and an end on the blade tip side of a pultruded semi-finished product. The pultruded semi-finished product may be the same one as extends over the entire length between the two stated ends, or different pultruded semi-finished products within a layer. The carbon fiber material sheet may include a plurality of longitudinal portions and/or be formed of a single material sheet, the carbon fibers of which extend between the two stated ends. In any event, the sheet is configured and arranged such that it is in electrical contact with the two end faces of the pultruded semi-finished products arranged in a layer and at the same time is connected electrically with the lightning conductor. The carbon fiber material sheet may be integrated particularly simply into the spar cap assembly, since it may be readily connected to the other elements of the spar cap assembly due to its material properties. The sheet does not in this case serve to transmit a lightning current, but rather to transmit an equipotential bonding current.

In one configuration, the sheet extends over the entire length of the spar cap. The equipotential bonding element thus encompasses the spar cap over its entire length. This may in particular be achieved in that the blade tip- and blade root-side end faces of the longest pultruded semi-finished products, which extend over the entire length of the spar cap, rest against the sheet. The sheet may in this case be arranged between two of the layers of pultruded semi-finished products.

In one configuration, the sheet rests flat against the spar cap and/or against the lightning conductor, in particular in each case over the entire length of the spar cap. This means that the electrical contact between equipotential bonding element and spar cap is not limited to the two end faces, but rather additionally includes extensive contact over the longitudinal extent of the spar cap. Although the electrically conductive carbon fibers of the spar cap are accessible only to a limited extent due to their incorporation in pultruded semi-finished products, the extensive contact brings about an improvement in equipotential bonding.

In one configuration, one of the end faces is arranged obliquely relative to the longitudinal direction of the spar cap, wherein a normal vector to the end face is oriented substantially orthogonally relative to a transverse direction of the spar cap and the ratio of the thickness of the pultruded semi-finished product on which the end face is formed and the extent of the end face in the longitudinal direction of the spar cap lies in the range from 1:5 to 1:50. The ratio may in particular lie in the range from 1:10 to 1:30, for example around 1:20. It goes without saying that both or all the end faces against which the sheet rests may also be correspondingly oblique in form. As a result of the oblique configuration of the end face, the contact face between pultruded semi-finished product and equipotential bonding element is enlarged, without weakening the spar cap structurally. Moreover, contacting of the open rovings is possible at the contact faces, whereby the contact resistance between the carbon fiber sheet and the pultruded semi-finished products may be reduced.

In one configuration, the equipotential bonding element includes a further sheet of a carbon fiber material, which rests against the sheet and/or against the lightning conductor and against at least one end face of a further pultruded semi-finished product of the spar cap. In this way, electrical contacting of the pultruded semi-finished products forming the spar cap is further improved.

In one configuration, the spar cap includes a number of layers arranged on top of one another of pultruded semi-finished products, wherein each of the layers has an end face on the blade root side and an end face on the blade tip side and the further sheet rests at least against half of the blade root-side end face and at least against half of the blade tip-side end face. This measure also further improves equipotential bonding.

In one configuration, the further sheet rests, between two adjacent end faces against which it rests, flat against a pultruded semi-finished product. In this way, the further sheet also contacts the adjacent pultruded semi-finished products not only in the region of the end faces but rather also extensively at an upper face.

In one configuration, the further sheet is subdivided into two longitudinal portions, of which one rests against at least half of the blade root-side end face and the other against at least half of the blade tip-side end face. The further sheet may thus be formed of two longitudinal portions, between which a gap remains. Each of the longitudinal portions may additionally rest against the sheet, such that overall good equipotential bonding is achieved with relatively low materials usage.

In one configuration, the end faces of a top one of the layers do not rest against the equipotential bonding element. The top layer means that the layer which is arranged furthest towards the top when the spar cap assembly is placed in a manufacturing mold for a rotor blade half-shell, that is, is at the greatest distance from an aerodynamic surface of the half-shell in question. This top layer generally has the shortest length and extends substantially in a middle longitudinal portion of the rotor blade. Under certain circumstances, satisfactory equipotential bonding may be achieved without electrical contacting of these end faces, so making possible a particularly compact embodiment of the equipotential bonding element.

In one configuration, the sheet and/or the further sheet extend(s) over the entire width of the spar cap. This results in particularly extensive contact, which in particular also encompasses a plurality of pultruded semi-finished products arranged next to one another.

In one configuration, the sheet and/or the further sheet includes a bidirectional woven carbon fiber material. This ensures relatively high electrical conductivity in a transverse direction of the spar cap, that is, a particularly good connection between an adjacently arranged lightning conductor and the spar cap.

In one configuration, the sheet and/or the further sheet includes unidirectionally arranged carbon fibers, which are arranged in the longitudinal direction of the spar cap. In this case, the electrical conductivity in the transverse direction is lower, which may be compensated by sufficient thickness of the sheet or of the further sheet. The advantage consists in the fact that the sheet in question may make a contribution to the strength of the spar cap.

In one configuration, the sheet is arranged between two layers of pultruded semi-finished products and/or the further sheet is a cover sheet which is arranged on a top of the spar cap. In this way, on the one hand good electrical contact is achieved between the respective sheet and the elements of the spar cap. At the same time, the exact arrangement of the pultruded semi-finished products in a manufacturing mold is not made significantly more difficult.

In one configuration, the pultruded semi-finished products, the lightning conductor and the equipotential bonding element are embedded in a common plastics matrix and take the form of a prefabricated assembly for integration into a wind turbine rotor blade after curing of the plastics matrix. Embedding may in particular proceed by a vacuum infusion method. To this end, the spar cap assembly may be prefabricated in a specific manufacturing mold. Integration into a wind turbine rotor blade is simplified thereby. Alternatively, the elements of the spar cap assembly may be connected together with further components of the wind turbine rotor blade, for instance in a manufacturing mold for a rotor blade half-shell into which the elements of the spar cap assembly and further materials for the other elements of the half-shell are placed.

The invention is likewise directed to a wind turbine rotor blade with a spar cap assembly in one of the configurations described above. The wind turbine rotor blade may in particular include a pressure-side and a suction-side rotor blade half-shell, in which in each case a spar cap assembly may be incorporated, and one or more webs, which are arranged between the spar cap assemblies. The lightning conductor of the spar cap assembly or the lightning conductor of the two spar cap assemblies may in each case be connected with one or more lightning receptors of the wind turbine rotor blade.

### BRIEF DESCRIPTION OF THE DRAWINGS

The invention will now be described with reference to the drawings wherein:

FIG. 1 is a schematic, longitudinally sectional representation of a spar cap assembly according to the invention;

FIG. 2 is a likewise schematic, longitudinally sectional representation of another spar cap assembly according to the invention;

FIGS. 3A to 3I are plan views of elements of another spar cap assembly according to the invention at successive points in the process of being placed into a manufacturing mold; and,

FIG. 4 shows the spar cap assembly of FIG. 2 in a schematic, cross-sectional view.

### DESCRIPTION OF THE PREFERRED EMBODIMENTS OF THE INVENTION

The same reference signs are used for corresponding elements in all the embodiments shown.

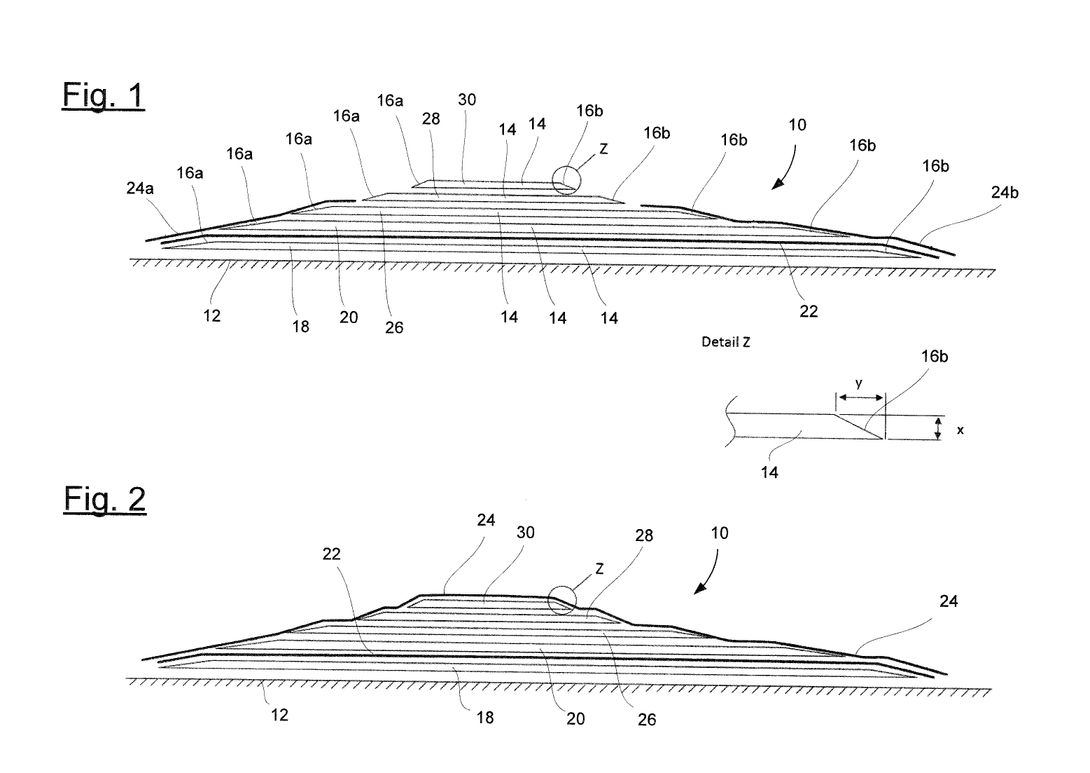

The schematically illustrated spar cap assembly 10 of FIG. 1 is arranged on a manufacturing mold 12, on which all the elements of the spar cap assembly 10 will be joined together using a vacuum infusion method. The section plane of FIG. 1 by way of example contains five layers of pultruded semi-finished products 14, each layer having a plurality of semi-finished products arranged next to one another. The semi-finished products each extend from an end on the blade root side, shown on the left in FIG. 1, to an end on the blade tip side, shown on the right in FIG. 1. At the stated ends all the layers in each case include an oblique end face 16, the normal vector of which is arranged substantially perpendicular to a transverse direction of the spar cap, which extends into the plane of the drawing.

The singled-out detail Z shows by way of example, for one of the end faces 16, how the thickness x of the pultruded semi-finished product 14 forms a ratio with the extent y of the end face 16 in the longitudinal direction of the spar cap. This ratio amounts in the embodiment shown to around 1:20, that is, is significantly smaller than shown in the drawing, which is not to scale.

Between the bottom layer 18 and the second layer 20 of the pultruded semi-finished products 14 a sheet 22 of a carbon fiber material is arranged which is also designated below as first sheet 22. This extends over the entire length of the spar cap and rests flat against the pultruded semi-finished products 14 of the bottom layer 18 and the pultruded semi-finished products 14 of the second layer 20. Moreover, the first sheet 22 rests flat against the blade root-side end faces 16a and blade tip-side end faces 16b of the pultruded semi-finished products 14 of the bottom layer 18. Furthermore, the first sheet 22 is connected to a lightning conductor not shown in FIG. 1. Reference is made to the further figures in this respect.

The first sheet 22 forms part of an equipotential bonding element of the spar cap assembly 10. Another component of this equipotential bonding element is formed by a further sheet 24 of a carbon fiber material which is also designated below as second sheet 24. This is subdivided into a blade root-side longitudinal portion 24a and a blade tip-side longitudinal portion 24b, between which there is a gap.

The blade root-side longitudinal portion 24a of the second sheet 24 rests against the beveled blade root-side end face 16a of the pultruded semi-finished products 14 of the second layer 20 and of the third layer 26 and in the region of the blade root-side end face 16a of the pultruded semi-finished products 14 of the bottom layer 18 against the first sheet 22 of the equipotential bonding element. Moreover, the blade root-side longitudinal portion 24a of the second sheet 24 rests flat against a portion of the top of the pultruded semi-finished product 14 of the third layer 26.

The blade tip-side longitudinal portion 24b of the second sheet 24 rests against the blade tip-side end faces 16b of the pultruded semi-finished products 14 of the second layer 20 and the third layer 26, and in the region of the blade tip-side end face 16b of the pultruded semi-finished products 14 of the first layer 18 against the first sheet 22. Moreover, between the end faces 16b of the pultruded semi-finished products 14 of the second layer 20 and the third layer 26, this longitudinal portion 24b of the second sheet 24 rests flat against the top of the pultruded semi-finished products 14 of the second layer 20. The two longitudinal portions 24a, 24b of the second sheet 24 are likewise connected to a lightning conductor, not shown in FIG. 1, as will be explained further below.

The pultruded semi-finished products 14 of a fourth layer 28 and a top layer 30 are not covered by the two longitudinal portions 24a and 24b of the second layer 24 and are thus not in direct contact with the equipotential bonding element.

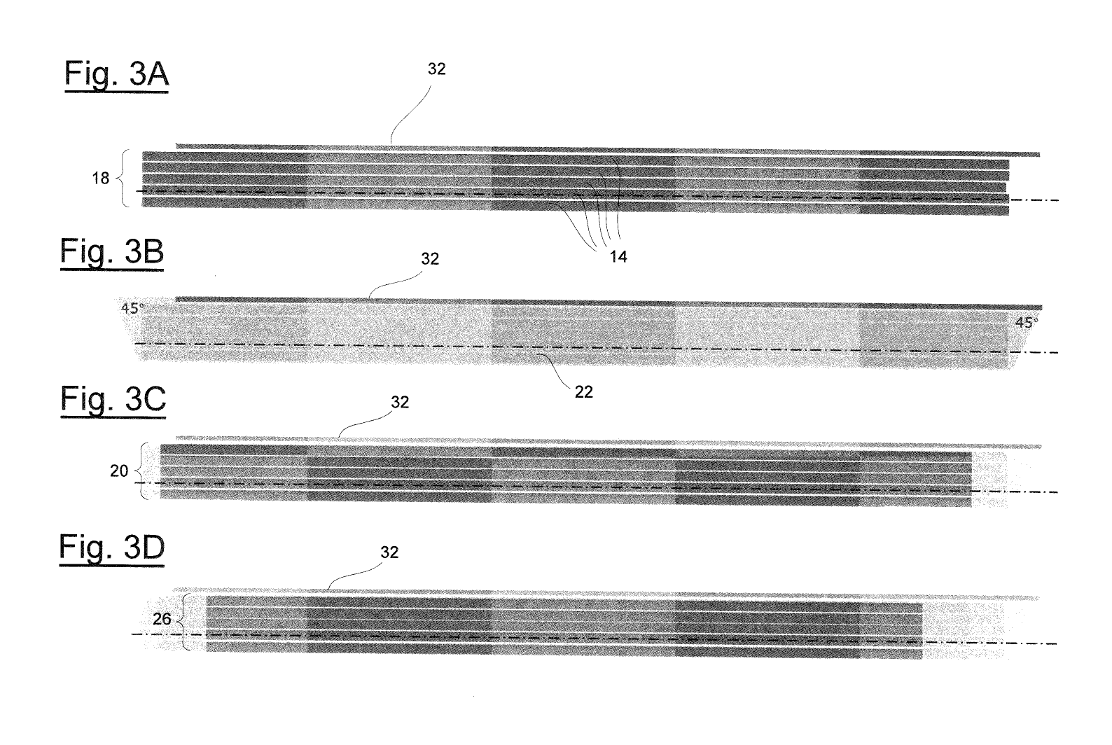

The embodiment of FIG. 2 resembles the embodiment of FIG. 1 in terms of layers 18, 20, 26, 28, 30 and the first sheet 22 of the equipotential bonding element. Differences consist in the configuration of the second sheet 24 of the equipotential bonding element which, in the embodiment of FIG. 2, is a cover sheet likewise extending over the entire length of the spar cap and resting against all of the blade root-side and blade tip-side end faces 16a, 16b of the second layer 20, the third layer 26, the fourth layer 28 and the top layer 30 and additionally against the tops, arranged between these end faces 16a, 16b, of the respective pultruded semi-finished products 14. Moreover, in the region of the blade root-side and blade tip-side end faces 16a, 16b of the bottom layer 18 the second sheet 24 rests flat against the portions located there of the first sheet 22. As also in the embodiment of FIG. 1, the first sheet 22 and the second sheet 24 of the equipotential bonding element are connected electrically to a lightning conductor, not shown in FIG. 2.

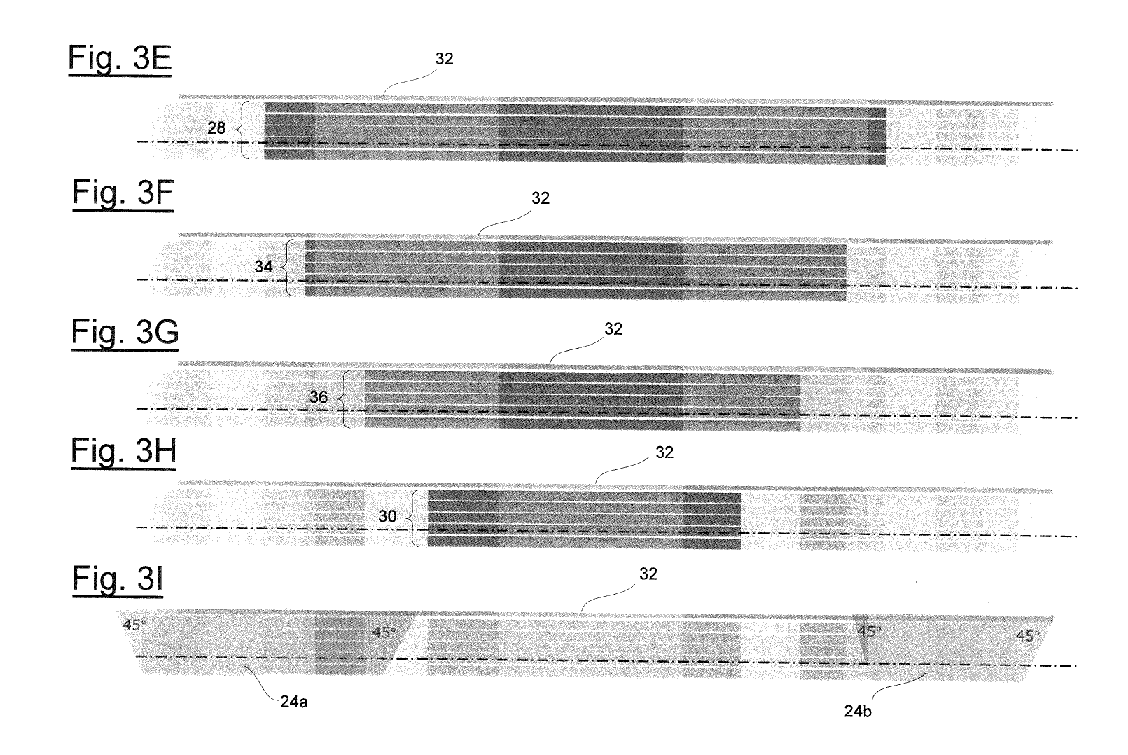

The structure of an embodiment resembling FIG. 1 of a spar cap assembly will be explained in greater detail with reference to FIGS. 3A to 3I, which each show plan views. A blade root-side end of the elements shown is depicted consistently on the left in all parts of FIG. 3, a blade tip-side end being depicted on the right.

FIG. 3A shows a bottom layer 18, which includes five pultruded semi-finished products 14 arranged next to one another. Extending adjacent the bottom layer 18 is a lightning conductor 32, which does not extend right up to the blade root but at the blade tip-side end of the pultruded semi-finished products 14 of the bottom layer 18 protrudes somewhat in the direction of the blade tip. The lightning conductor 32 is made of copper in the example.

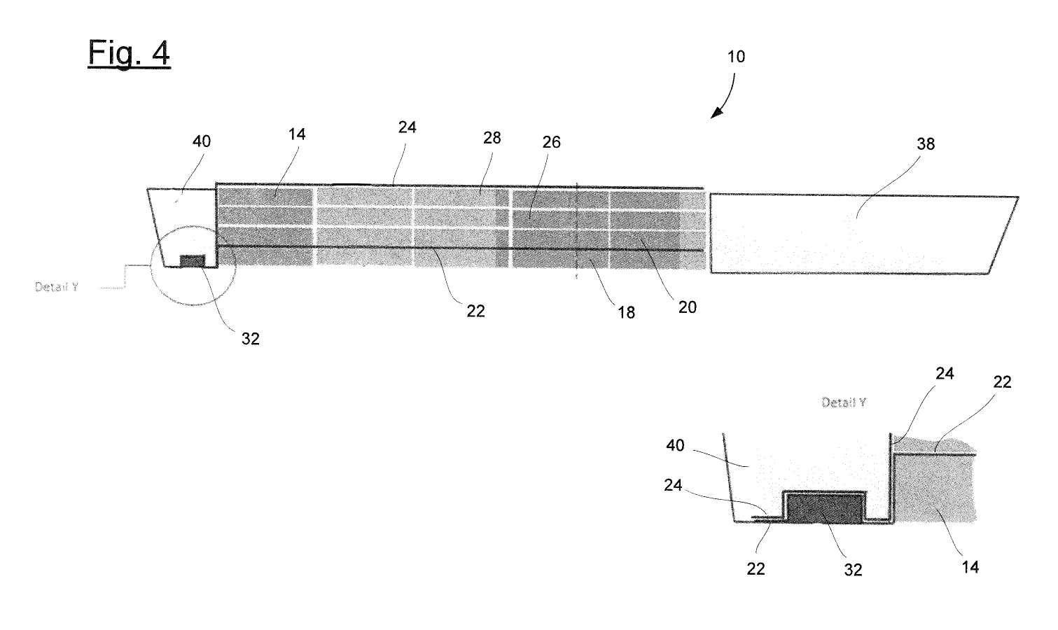

FIG. 3B shows that in a step following FIG. 3A, a first sheet 22 of a carbon fiber material, made in the example of a biaxial woven fabric, is placed onto the arrangement of FIG. 3A. This first sheet 22 extends over the entire length of the bottom layer 18 and, at the blade root- and blade tip-side ends, where the first sheet 22 is beveled at an angle of around 45°, preferably within an angular range of between 40° and 60°, protrudes beyond the bottom layer 18. The first sheet 22 extends over the entire width of the spar cap or over the entire width of the bottom layer 18 made of the five pultruded semi-finished products 14 arranged next to one another. Furthermore, the first sheet 22 extends on one side beyond this width and beyond the lightning conductor 32, where it likewise protrudes somewhat. Details in this regard will be explained below with reference to FIG. 4.

FIG. 3C shows how a second layer 20 likewise of five pultruded semi-finished products 14 is placed onto the arrangement of FIG. 3B. These pultruded semi-finished products 14 are somewhat shorter than the pultruded semi-finished products 14 of the first layer 18.

FIG. 3D shows a fourth layer 28, likewise having five pultruded semi-finished products 14 arranged next to one another, which layer is placed onto the arrangement of FIG. 3C and is again somewhat shorter than the second layer 20.

FIGS. 3E to 3H show further working steps, in which in each case a further layer, namely a fourth layer 28, a fifth layer 34, a sixth layer 36 and a top layer 30, each having five pultruded semi-finished products 14 arranged next to one another, with a length decreasing from layer to layer, is put in place.

Finally, FIG. 3I shows how the second sheet 24 of a carbon fiber material which has been subdivided into two longitudinal portions 24a, 24b is put in place. The longitudinal portions of the second sheet 24 are dimensioned such that they each encompass a part of the end faces 16a, 16b of the pultruded semi-finished products 14 of some of the lower layers. Other end faces 16a, 16b, in particular those of the pultruded semi-finished products 14 of the top layer 30, are not encompassed by the second sheet 24.

FIG. 4 shows a cross-section through a spar cap assembly 10 at a longitudinal position at which the spar cap has been built up from four layers 18, 20, 26, 28 of in each case five pultruded semi-finished products 14 arranged next to one another. In cross-section each of the pultruded semi-finished products 14 is rectangular and has dimensions in the range from 1 mm to 10 mm (thickness) times 40 mm to 200 mm (width).

The right-hand side of FIG. 4, pointing towards the profile nose edge, shows a cross-sectionally quadrangular insert 38 of a core material. A further insert 40 of a core material is located on the other side of the spar cap facing the profile end edge. This insert 40 is likewise cross-sectionally quadrangular, but has at the bottom, which faces a manufacturing mold for the spar cap assembly or rotor blade half-shell, a cross-sectionally rectangular groove in which the lightning conductor 32 is arranged.

Between the bottom layer 18 and the second layer 20 of the pultruded semi-finished products 14 the first sheet 22 of the carbon fiber material is shown. This terminates on the right in FIG. 4, towards the profile nose edge, flush with the pultruded semi-finished products 14 terminating there or just before, such that it does not protrude towards the insert 38. The first sheet 22 extends over the entire width of the first layer 18 and therebeyond on the left in FIG. 4, towards the profile end edge. As the enlarged view of detail Y on the bottom right shows, the first sheet 22 firstly extends down between the depicted end edge-side pultruded semi-finished product 14 of the bottom layer 18 and the insert 40 and then, as it continues towards the profile end edge, lines the groove formed in the insert 40, such that it rests flat against three sides of the lightning conductor 32. Continuing on, the first sheet 22 then protrudes somewhat beyond the profile end edge-side face of the lightning conductor 32.

The second sheet 24 covers the fourth layer 28 of the pultruded semi-finished products 14 over the entire width of the spar cap, wherein it likewise does not protrude towards the profile nose edge. Continuing towards the profile end edge, it firstly extends down between the end edge-side, pultruded semi-finished products 14 of the fourth layer 28, the third layer 26 and the second layer 28 on the one hand and the insert 40 on the other hand, then on between the insert 40 and the first sheet 22. It thus rests against the first sheet 22 in the region of the groove, such that electrical contact with the lightning conductor 32 is produced via the first sheet 22.

The entire arrangement of FIG. 4 may, in particular in the vacuum infusion method in a manufacturing mold provided for this purpose, be embedded in a plastics matrix, resulting in a prefabricated spar cap assembly 10 which may be subsequently integrated into a wind turbine rotor blade.

It is understood that the foregoing description is that of the preferred embodiments of the invention and that various changes and modifications may be made thereto without departing from the spirit and scope of the invention as defined in the appended claims.

### LIST OF REFERENCE NUMERALS USED

10 Spar cap assembly
12 Manufacturing mold
14 Pultruded semi-finished product
16 End face
16a End face on the blade root side
16b End face on the blade tip side
18 Bottom layer
20 Second layer
22 First sheet
24 Second sheet
24a Blade root-side longitudinal portion of second sheet
24b Blade tip-side longitudinal portion of second sheet
26 Third layer
28 Fourth layer
30 Top layer
32 Lightning conductor
34 Fifth layer
36 Sixth layer
38 Profile nose edge-side insert
40 Profile end edge-side insert

What is claimed is:

1. A spar cap assembly for a wind turbine rotor blade, the spar cap assembly comprising:
a carbon fiber-reinforced spar cap;
a lightning conductor extending along said spar cap;
an equipotential bonding element electrically conductively connecting said spar cap and said lightning conductor with each other;
said spar cap including a plurality of layers of pultruded semi-finished products each defining a blade root side having a first end with a first end face and a blade tip side having a second end with a second end face; and,
said equipotential bonding element including a sheet of a carbon fiber material, which rests against said first end face of said first end on said blade root side of one of said pultruded semi-finished products and against said second end face of said second end on said blade tip side of one of said pultruded semi-finished products.

2. The spar cap assembly for a wind turbine rotor blade of claim 1, wherein:
said spar cap has a length; and,
said sheet extends over all of said length of the spar cap.

3. The spar cap assembly for a wind turbine rotor blade of claim 1, wherein said sheet is arranged between two of said plurality of layers of pultruded semi-finished products.

4. The spar cap assembly for a wind turbine rotor blade of claim 1, wherein said sheet rests flat against at least one of said spar cap and said lightning conductor.

5. The spar cap assembly for a wind turbine rotor blade of claim 1, wherein:
said spar cap defines a longitudinal direction and a transverse direction; and,
one of said first end face and said second end face is arranged obliquely relative to said longitudinal direction of said spar cap so as to form an oblique end face wherein a normal vector to said oblique end face is oriented substantially orthogonally relative to said transverse direction and a ratio of the thickness of the pultruded semi-finished product on which said oblique end face is formed and an extent of said oblique end face in said longitudinal direction of said spar cap lies in a range from 1:5 to 1:50.

6. The spar cap assembly for a wind turbine rotor blade of claim 1, wherein said equipotential bonding element includes a further sheet of a carbon fiber material which rests against at least one of said sheet and said lightning conductor and against at least one end face of a further pultruded semi-finished product of said spar cap.

7. The spar cap assembly for a wind turbine rotor blade of claim 1, wherein:
said equipotential bonding element includes a further sheet of a carbon fiber material;
said spar cap has a number of said layers of pultruded semi-finished products arranged on top of one another, wherein each of said number of layers has an end face on the blade root side and an end face on the blade tip side; and,
said further sheet rests at least against half of said blade root side end faces and at least against half of said blade tip side end faces.

8. The spar cap assembly for a wind turbine rotor blade of claim 7, wherein said further sheet rests, between two adjacent end faces against which it rests, flat against a pultruded semi-finished product.

9. The spar cap assembly for a wind turbine rotor blade of claim 7, wherein:
said further sheet is subdivided into a first longitudinal portion and a second longitudinal portion;
said first longitudinal portion rests against at least half of the blade root side end faces; and,
said second longitudinal portions rest against at least half of the blade tip side end faces.

10. The spar cap assembly for a wind turbine rotor blade of claim 1, wherein:
said plurality of layers includes a top layer; and,
said first end face and said second end face of said top layer do not rest against said equipotential bonding element.

11. The spar cap assembly for a wind turbine rotor blade of claim 1, wherein:
said spar cap has a width;
said equipotential bonding element includes a further sheet of a carbon fiber material; and,
at least one of said sheet and said further sheet extends over the entirety of said width of the spar cap.

12. The spar cap assembly for a wind turbine rotor blade of claim 1, wherein:
said equipotential bonding element includes a further sheet of a carbon fiber material; and,
at least one of said sheet and said further sheet includes a bidirectional woven carbon fiber material.

13. The spar cap assembly for a wind turbine rotor blade of claim 1, wherein:
said equipotential bonding element includes a further sheet of a carbon fiber material;
said spar cap defines a longitudinal direction; and,
at least one of said sheet and said further sheet includes unidirectionally arranged fibers arranged in said longitudinal direction of said spar cap.

14. The spar cap assembly for a wind turbine rotor blade of claim 1, wherein:
said equipotential bonding element includes a further sheet of a carbon fiber material; and,
said further sheet is a cover sheet arranged on a top of said spar cap.

15. The spar cap assembly for a wind turbine rotor blade of claim 1 wherein:
said pultruded semi-finished products, said lightning conductor and said equipotential bonding element are embedded in a common plastics matrix and take the form of a prefabricated assembly configured to be integrated into the wind turbine rotor blade after curing of the plastics matrix.

16. A wind turbine rotor blade comprising:
a spar cap assembly including a carbon fiber-reinforced spar cap;
said spar cap assembly having a lightning conductor extending along said spar cap;
said spar cap assembly further having an equipotential bonding element electrically conductively connecting said spar cap and said lightning conductor with each other;
said spar cap including a plurality of layers of pultruded semi-finished products each defining a blade root side having a first end with a first end face and a blade tip side having a second end with a second end face; and,
said equipotential bonding element including a sheet of a carbon fiber material, which rests against said first end face of said first end on said blade root side of one of said pultruded semi-finished products and against said second end face of said second end on said blade tip side of one of said pultruded semi-finished products.
